(19) United States
(12) Patent Application Publication
(10) Pub. No.: US 2005/0242311 A1
(43) Pub. Date: Nov. 3, 2005

(54) Expansion element

(75) Inventors: Eike Willers, Stuttgart (DE); Harald Ruoff, Gerstetten (DE)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: Behr Thermot-tronik GmbH, Kornwestheim (DE)

(21) Appl. No.: 11/114,722

(22) Filed: Apr. 26, 2005

(30) Foreign Application Priority Data
Apr. 29, 2004 (DE) 102004022351.3-12

(51) Int. Cl. F16K 31/165; F16K 31/02

(52) U.S. Cl. 251/61; 251/129.03

(57) ABSTRACT

The present invention relates to an expansion element for thermostatic valves, having a housing, an expansion material arranged in the housing, an actuating element, which can be moved relative to the housing when the volume of the expansion material changes, and electrically activated means for heating the expansion material. In accordance with the invention, the means for heating the expansion material has two electrodes, which are in contact with the expansion material, the expansion material is electrically conductive and constitutes an electrical resistor. The invention is employed, for example, in connection with thermostatic valves in coolant systems of motor vehicles.

### FIELD OF THE PRESENT INVENTION

The present invention relates to an expansion element for thermostatic valves, having a housing, an expansion material arranged in the housing, an actuating element, which can be moved relative to the housing in response to changes in the volume of the expansion material, and means which can be electrically activated for heating the expansion material to increase the volume of the expansion material.

### BACKGROUND OF THE PRESENT INVENTION

Expansion elements for thermostatic valves of cooling systems in motor vehicles are known, wherein an expansion material can be electrically heated in order to displace an operating point of the expansion element. For example, the expansion material is heated in case an actual driving situation of the motor vehicle, for example under full load at low speeds, leads to the expectation of an increased need for cooling. By heating the expansion material, the thermostatic valve can be opened, even before the cooling water temperature normally required for this has been reached. Thick film resistors arranged in the expansion material, plates, cylinders or wound wires are used as heating elements. It is also known to electrically heat a piston of the expansion element.

Harsh environmental conditions with high expansion material pressures up to approximately 400 bar, partially high ambient temperatures, together with little heat removal, as well as vibrations during the driving operation, all make great demands on the heating elements and in particular on the electrical power supply lines and their connecting lines. Making the electrical connections and conducting them further through a housing of a thermostatic valve is also critical.

### SUMMARY OF THE PRESENT INVENTION

It is the object of the present invention to create an expansion element which is simple to produce and can be dependably electrically heated.

In accordance with the invention, an expansion element for thermostatic valves is provided for this, which has a housing, an expansion material arranged in the housing, an actuating element, which can be moved relative to the housing when the volume of the expansion material changes, and means for heating the expansion material, which can be electrically activated, wherein the means for heating the expansion material has two electrodes which are in contact with the expansion material, wherein the expansion material is electrically conductive and constitutes an electric resistor.

Because the expansion material itself constitutes the electrical resistor, it is possible to heat the expansion material directly. As a result, it is possible to achieve a very uniform heating of the expansion material and therefore a very rapid, dependable deflection of the actuating element. It is not necessary in particular to provide separate heating elements, so that a considerable simplification of the construction and considerable cost savings can be achieved. The critical connection of the separate heating elements in particular, which during the operation are exposed to the harshest environmental conditions, can be omitted with the present invention.

In accordance with a further development of the invention, the expansion material is provided with electrically conductive and resistive particles.

In this way the electrical resistance of the expansion material can be set in a simple manner by means of the number of particles, their size, as well as their electrical properties. It is therefore possible to employ a conventional, proven expansion material for the expansion element in accordance with the invention, which merely needs to be provided with electrically conductive particles. In this case the particle size can be very small, down into the nanometer range, so that the hydraulic properties of the expansion material are not, or only negligibly changed.

In accordance with further development of the invention, the expansion material has graphite particles, metal particles and/or particles made of a material with positive temperature coefficients.

For example, metal powder of a particle size down into the nanometer range is introduced into the expansion material. Such a powder with a positive resistance temperature coefficient, or PCT powder, wherein an electrical resistance value increases with increasing temperature, makes possible a rapid and dependable response by the expansion element when employed in cooling systems of motor vehicles.

In accordance with a further development of the invention, each of the partides has dimensions in the micrometer range. For example, the particle size of each partide lies between 1 μm and 10 μm. Such particle dimensions have been shown to be particularly advantageous.

In accordance with a further development of the invention, one of the electrodes is the housing, which is in contact with the expansion material and has been designed to be electrically conductive at least over parts of it.

When used in the cooling system of motor vehicles, the housing, which customarily is immersed in water, is usefully connected to ground. A further simplification results from using the housing as one of the two electrodes in that only one separate electrode must be arranged in the expansion material. As a result, only one electrical feed line needs to be introduced into the housing in a sealed and insulated manner.

In accordance with a further development of the invention, at least one electrode protrudes into an interior space of the housing and is in contact with the expansion material.

Because at least one of the electrodes protrudes into the interior space of the housing it is possible to achieve a particularly uniform heating of the expansion material when it is charged with an electrical current. It is for example also possible to provide two electrodes protruding into the expansion material, wherein one of the electrodes is then connected to the electrical power supply and the other electrode to ground. However, in view of a uniform electrical current distribution it is of course also possible to connect several electrodes to the electrical power supply and/or several electrodes to ground. It is for example also possible to employ a cylinder-shaped electrode, wherein the second electrode then lies on the center longitudinal axis of the latter.

In accordance with a further development of the invention, the actuating element is a piston, a portion of which is connected with the expansion material, wherein the piston constitutes one of the electrodes.

In this way it is possible to achieve a further simplification in that the piston protruding into the expansion material is used as an electrode.

In accordance with a further development of the invention, the piston constitutes one of the electrodes and the housing, which is in contact with the expansion material, constitutes the other electrode.

With such an embodiment of the expansion element in accordance with the invention it is possible to do entirely without separate electrodes, because the piston, as well as the housing, each have a double function. For heating the expansion material, the piston is connected to the electrical power supply and the housing to ground. This is advantageous for safety reasons, in particular in those cases where the housing is immersed in cooling water.

Further characteristics and advantages of the invention ensue from the claims and the subsequent description of preferred embodiments in connection with the drawings.

### BRIEF DESCRIPTION OF THE DRAWINGS

Further features, embodiments, and advantages of the present invention will become apparent from the following detailed description with reference to the drawings, wherein:

FIG. 1 is a sectional view of a thermostatic valve with an expansion element in accordance with a preferred embodiment of the present invention;

FIG. 2 is a schematic representation of an alternative electrode arrangement in an expansion element in accordance with the present invention;

FIG. 3 is a another alternative electrode arrangement in an expansion element in accordance with the present invention;

FIG. 4 is a sectional view of an expansion element in accordance with a further alternative embodiment of the present invention; and

FIG. 5 is a sectional view of an expansion element in accordance with a still further alternative embodiment of the present invention.

### DETAILED DESCRIPTION OF PREFERRED EMBODIMENTS

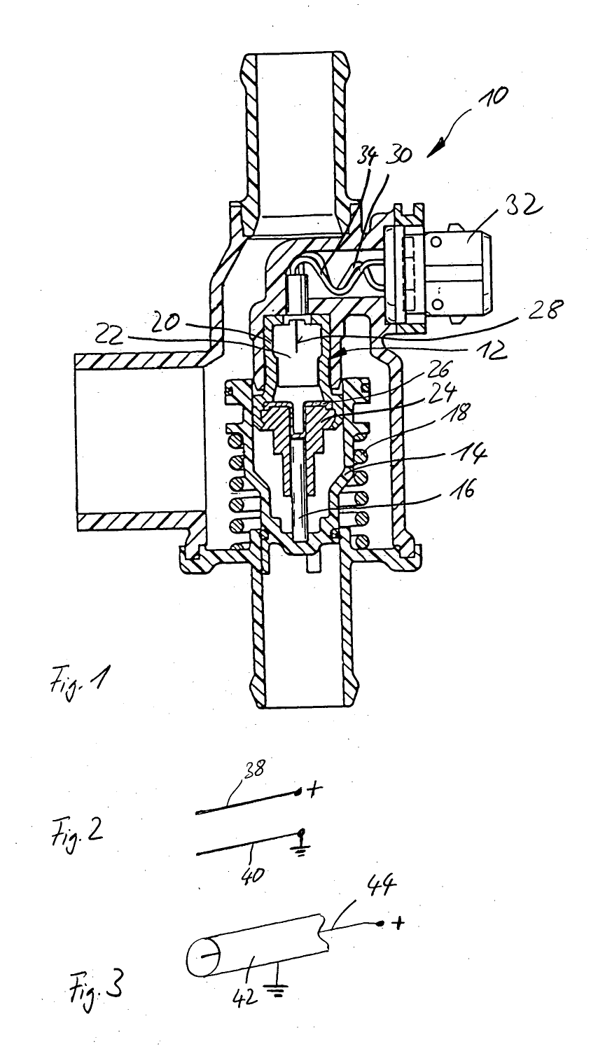

Referring now to the drawings, a first preferred embodiment is a thermostatic valve 10 is represented in a sectional view in FIG. 1, which has an expansion element 12 which can be electrically heated, by means of which a gate valve 14 can be moved. The gate valve 14 is moved by means of a piston 16 of the expansion element 12. In its position of rest, the gate valve 14 is prestressed by means of a spring 18. If the gate valve 14 is moved into the position of rest by means of the spring 18, the piston 16 is simultaneously pushed back into its position of rest.

Besides the piston 16, the expansion element 12 has a housing 20, in which an expansion material 22 is arranged. The housing 20 is closed off by means of a plug 24 and a diaphragm 26 of rubber, or any other suitable flexible material, arranged between the plug 24 and the expansion material 22. The plug 24 has a central through-bore, in which the piston 16 is guided.

If the expansion material 22, for example wax, is heated, its volume expands. As a result, and as represented in FIG. 1, the rubber diaphragm 26 is pushed into the central through-bore of the plug 24 and in the process also pushes the piston 16 away from the housing 20, downward in FIG. 1. If the volume of the expansion material 22 is reduced again because of cooling, the rubber diaphragm 26 is pulled back out of the central through-bore of the plug 24, and the piston 16 is pushed back again by the spring 18. Heating of the expansion material occurs by heat transfer from the cooling water flowing through the thermostatic valve 10 to the housing 20 and then to the expansion material 22.

In order to move the gate valve 14 already at a cooling water temperature at which the expansion material 22 does not undergo a volume change sufficient to noticeably move the piston 16, means for electrically heating the expansion material 22 is provided in the thermostatic valve 10. This means has an electrode 28, which protrudes into the expansion material and which can be provided with electrical energy from an electrical power supply via an electrical connecting cable 30 and a plug 32. A second connecting cable 34 is electrically connected with the housing 20 and connects the housing 20 with ground. Furthermore, the expansion material 22 in the housing 20 is electrically conductive and resistive. This is achieved by mixing electrically conductive particles into the expansion material 22, each of which constitutes an electrical resistor itself. Since the expansion material 22 is conductive, a current flows between the electrode 28 and the housing 20 connected to ground if a voltage is applied to the electrode 28. In the course of this the electrical current flows through the expansion material 22, which is provided with electrically conductive and restrictive particles, so that the expansion material 22 is heated. With sufficient heating of the expansion material 22, the latter will then be expanded again and displace the piston 16.

Since the expansion material 22 is directly heated and, in contrast to the prior art, no separate heating elements need be employed, the construction of the expansion element 12 has been considerably simplified. In particular, no separate heating elements need to be electrically connected, which is of great advantage in view of the considerable pressures in the expansion element 12 of up to 400 bar, the considerable heating of the expansion element, and the strong vibrations during driving operations. Since the expansion material 22 itself is electrically conductive, it is also possible to achieve a very homogeneous heating of the expansion material. As a result, it is possible to achieve a very dependable and also rapid response of the expansion element 12 when being heated electrically. The size of the particles, preferably metal or graphite particles with positive temperature coefficients, lies in the range between 1 μm and 100 μm.

The schematic representation in FIG. 2 shows a possible electrode arrangement. The two electrodes 38, 40 protrude into the expansion material and, when a voltage difference is created between the electrodes 38, 40, an electrical current will flow between the electrodes 38, 40, which then leads to heating of the expansion material. For example, the electrode 40 can be connected with the housing 20 in an electrically conductive manner, and it is also possible to provide several electrodes 38, 40 in order to achieve as uniform as possible an electrical current distribution and therefore heating of the expansion material 22.

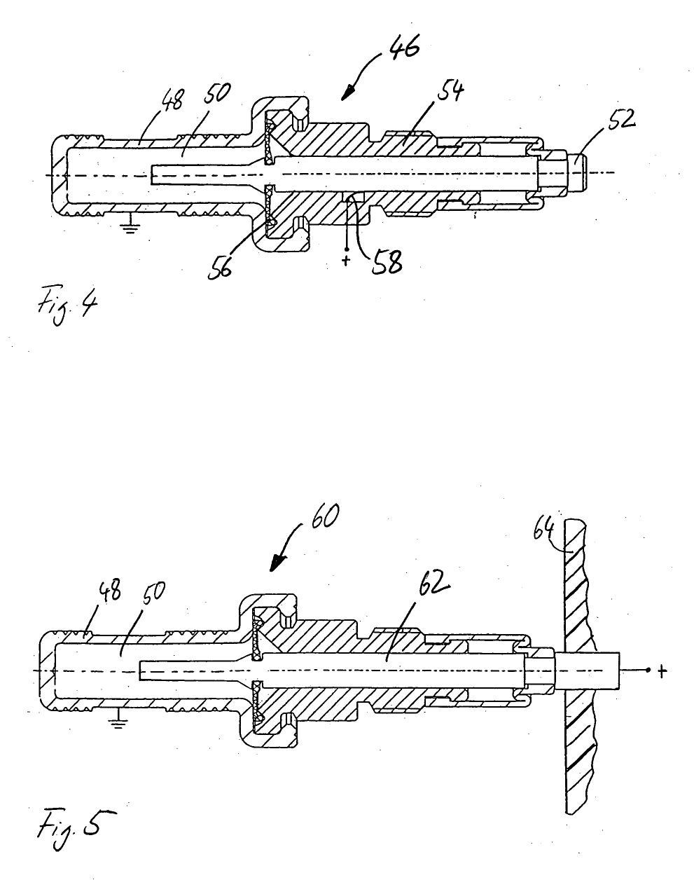

A further possible electrode arrangement is shown in the schematic representation of FIG. 3. In this case one electrode 42 is hollow-cylindrical, and a second electrode 44 lies on a central longitudinal axis of the hollow-cylindrical first electrode 42. It is possible by means of such an arrangement to achieve a particularly uniform electrical current distribution.

The sectional view in FIG. 4 shows a further embodiment of an expansion element 46 in accordance with the present invention. The expansion element 46 has a metal housing 48, in which an electrically conductive expansion material 50 is arranged. An end of a piston 52, made of an electrically conductive material, protrudes into the expansion material 50. The housing 48 is sealed by means of a plug 54, which has a central through-bore, in which the piston 52 is guided. An elastic diaphragm 56 is arranged on the open side of the housing 48 between the expansion material 50 and the plug 54. The elastic diaphragm 56 has a central through-opening, into which the piston 52 has been inserted. For sealing, the elastic diaphragm 56 enters into a circumferential groove of the piston 52. In the course of heating, the expansion material 50 expands inside the housing 48 and thereby pushes the piston 52 away from the housing 48, to the right in FIG. 4.

For achieving the electrical heating of the electrically conductive expansion material 50, the end of the piston 52 protruding into the expansion material 50 is used as the first electrode, and the housing 48 is connected to ground and is used as the second electrode. In case of a voltage difference between the piston 52 and the housing 48, a current therefore flows between the piston 52 and the housing 48, and the expansion material 50 is heated by means of the ohmic heat being generated by this. Since in the course of heating of the expansion material 50 the piston 52 performs a movement relative to the housing 48 and relative to the plug 54, it is connected by means of a wiper 58. However, the connection of the moving piston 52 can also be provided in any other way, for example by flexible cable feed lines. The expansion element 46 then does completely without any separate electrodes arranged in the expansion material 50. Because of this a considerable simplification of the construction becomes possible, Wherein in particular no defect-prone lead-through devices for electrical conductors through the housing 46 need be provided.

A further expansion element 60 in accordance with the present invention is represented in a sectional view in FIG. 5. With the exception of the wiper 58 and the associated feed line represented in FIG. 4, the expansion element 60 is constructed very similar to the expansion element 46 represented in FIG. 4, so that a further detailed description can be omitted. In contrast to the expansion element 46 of FIG. 4, in the expansion element 60 in accordance with FIG. 5 a piston 62 is fixed in place in relation to a thermostatic valve housing 64, indicated only schematically. In the course of heating the expansion material 50 in the housing 48 the piston 62 therefore remains at rest in respect to the thermostatic valve housing 64, and the housing 48 will be displaced, to the left in the representation of FIG. 5. Therefore a gate valve must then be actuated by the housing 46.

Since the piston 62 remains at rest in relation to the thermostatic valve housing 64, but is also in contact with the expansion material 50, the electrical connection of the expansion element 60 can be executed in a particularly simple manner. The piston 62 can be connected to the electrical power supply and the housing 48 is connected to ground. Therefore, an electrical current flows through the electrically conductive expansion material 50, so that it is heated. In this case the electrical connection of the housing 48 can take place by means of a wiper, or even indirectly via a coolant flowing around the housing 48. This is non-critical when the housing 48 is to be connected only to ground anyway. The electrical contact by means of a wiper is also non-critical if the housing 48 is to be connected only to ground.

As a whole, a considerable structural simplification of an expansion element, together with considerable cost savings in its manufacture, are made possible by the invention.

In view of the aforesaid written description of the present invention, it will be readily understood by those persons skilled in the art that the present invention is susceptible of broad utility and application. Many embodiments and adaptations of the present invention other than those herein described, as well as many variations, modifications, and equivalent arrangements, will be apparent from or reasonably suggested by the present invention and the foregoing description thereof, without departing from the substance or scope of the present invention. Accordingly, while the present invention has been described herein in detail in relation to preferred embodiments, it is to be understood that this disclosure is only illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

1. An expansion element for thermostatic valves comprising:
a. a housing,
b. an electrically conductive and resistive expansion material disposed in the housing,
c. an actuating element movable relative to the housing in response to changes in the volume of the expansion material, and
d. electrically activated means for heating the expansion material having two electrodes in contact with the expansion material for heating the expansion material to move said actuating element.

2. The expansion element of claim 1, characterized further in that said expansion material comprises electrically conductive and resistive particles.

3. The expansion element of claim 2, characterized further in that said expansion material particles comprise at least one of graphite particles, metal particles and partides of a material having a positive resistance temperature coefficient.

4. The expansion element of claim 2, characterized further in that said particles are of a size in the micrometer range.

5. The expansion element of claim 1, characterized further in that at least a portion of one of said two electrodes is embedded in said expansion material and is electrically connected to said housing.

6. The expansion element of claim 1, characterized further in that at least one of said electrodes protrudes into said housing in contact with said expansion material.

7. The expansion element of claim 1, characterized further in that said actuating element is a piston in contact with said expansion material and comprises one of said two electrodes.

8. The expansion element of claim 7, characterized further in that said housing is in contact with said expansion material and comprises the other of said two electrodes.

9. The expansion element of claim 8, characterized further in that said piston is connected to an electrical power supply and said housing is connected to ground for heating the expansion material.

10. The expansion element of claim 6, characterized further in that said actuating element is a piston in contact with said expansion material and comprises the other of said two electrodes.

11. The expansion element of claim 10, characterized further in that said piston is connected to an electrical power supply and said one of said electrodes is connected to ground.
